(19) United States
(12) Patent Application Publication
(10) Pub. No.: US 2018/0371799 A1
(43) Pub. Date: Dec. 27, 2018

(54) DOOR STOPPER

(71) Applicant: Anthony Luskin, Simi Valley, CA (US)

(72) Inventor: Anthony Luskin, Simi Valley, CA (US)

(21) Appl. No.: 15/635,171

(22) Filed: Jun. 27, 2017

(51) Int. Cl. E05B 63/18; E05C 17/54

(52) U.S. Cl. CPC E05B 63/185; E05C 17/54

(57) ABSTRACT

A door knob device for use upon existing door knobs located on a door member, comprising: two ring members; and a belt member. The two ring members are each adapted to slip over respective opposite door knobs of the door member. The belt member is connected between the two ring members and is adapted to extend around an edge of said door member and cover and prevent a door latch bolt of said door member from extending outwardly therefrom and connecting with a strike plate of a door frame, thereby preventing the door member from closing in a latched position. A combination of a door knob assembly and a door knob device for use upon the door knob assembly when located on a door member is also disclosed, the combination comprising a door knob assembly and a door knob device.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of door knob devices and more specifically to a door knob device for use upon existing door knobs located on a door member structured and arranged to prevent a door from inadvertently closing when a user prefers the door to be open or ajar.

### 2. Description of the Related Art

An annoyance of daily life occurs when a door you've intentionally left open or ajar “wants” to close on its own—forcing you to get up and open it again. You may, for example, have a child who can't sleep at night with their bedroom door fully closed—or fully open. What you need here is some means to keep the door partially open, or ajar; and the conventional wedge-type doorstop, which sticks out from the bottom of the door, is not ideal for this purpose.

Various attempts have been made to solve problems found in door knob devices designed prevent doors from closing in a latched position, thereby, enabling the door latch to be in an opened position art. Among these are found in: U.S. Pat. No. 5,004,279 to Ruth Radcliff; U.S. Pat. No. 5,291,631 to Craig A. Schjonemann; and U.S. Pat. No. 5,074,604 to Paul A. Merendino, et al. This prior art is representative of door knob devices designed prevent doors from closing in a latched position, thereby, enabling the door latch to be in an opened position.

Ideally, a door knob device for use upon existing door knobs located on a door member should be user-friendly and safe in-use and, yet should operate reliably and be manufactured at a modest expense. Thus, a need exists for a door knob device for use upon existing door knobs located on a door member structured and arranged to prevent a door from inadvertently closing when a user prefers the door to be open or ajar and to avoid the above-mentioned problems.

### BRIEF SUMMARY OF THE INVENTION

In view of the foregoing disadvantages inherent in the known door knob device art, the present invention provides a door knob device for use upon existing door knobs located on a door member (Entitled Door Stopper). The general purpose of the present invention, which will be described subsequently in greater detail is to provide a door knob device for use upon existing door knobs located on a door member structured and arranged to prevent a door from inadvertently closing when a user prefers the door to be open or ajar.

A door knob device for use upon existing door knobs located on a door member, comprising: two ring members; and a belt member. The two ring members are each adapted to slip over respective opposite door knobs of the door member. The belt member is connected between the two ring members and is adapted to extend around an edge of said door member and cover and prevent a door latch bolt of said door member from extending outwardly therefrom and connecting with a strike plate of a door frame, thereby preventing the door member from closing in a latched position.

A combination of a door knob assembly and a door knob device for use upon the door knob assembly when located on a door member, the combination comprising: a door knob assembly and a door knob device. The door knob assembly includes two opposing door knobs; and a latch assembly including a latch bolt. The latch bolt is adapted to releasably connect with a strike plate member attached to a frame housing the door member. The two opposing door knobs are mechanically and releasably connected to said latch assembly when located on the door member.

The present invention holds significant improvements and serves as a provides a door knob device for use upon existing door knobs located on a door member. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, door knob device for use upon existing door knobs located on a door member (Entitled Door Stopper), constructed and operative according to the teachings of the present invention.

FIG. 1 shows a perspective view illustrating a door knob device according to an embodiment of the present invention.

FIG. 2 is a perspective view illustrating a combination of a door knob assembly and a door knob device for use upon said door knob assembly when located on a door member according to an embodiment of the present invention of FIG. 1.

FIG. 3 is another perspective view illustrating the combination of a door knob assembly and a door knob device for use upon said door knob assembly when located on a door member according to an embodiment of the present invention of FIG. 1.

The various embodiments of the present invention will hereinafter be described in conjunction with the appended drawings, wherein like designations denote like element.

### DETAILED DESCRIPTION

As discussed above, embodiments of the present invention relate to door knob device and more specifically relates to a door knob device for use upon existing door knobs located on a door member (Entitled Door Stopper) structured and arranged to prevent a door from inadvertently closing when a user prefers the door to be open or ajar

Generally speaking, the Door Stopper comprises a specially designed simple, effective device for preventing a knob-equipped door from closing. The Door Stopper is a one-piece unit fabricated in rubber or a flexible plastic polymer, 14½ inches in total length, and consisting of two circular rings or loops—3½ inches in Outer Diameter and 2½ inches in Inner Diameter—joined by a flat belt or strap which measures 11 inches from the center-points of the two rings. The Door Stopper would be ¼-inch in thickness.

Use of the Door Stopper would be very simple: The two rings are simply slipped over the door's opposing knobs, such that the flat strap or belt extends around the edge of the door—and, if desired, slips over the tongue of the door lock. With the Door Stopper in place, the door will still be capable of motion, but it cannot be closed and latched, either intentionally or unintentionally.

The Door Stopper presents itself as a simple, easy-to-use household accessory that would cost little, last a long time, and perform a function that consumers, maintenance personnel, and housekeepers, etc., need and desire. The Door Stopper would effectively stop a door from closing on its own. The Door Stopper could also hold a door “open” or unlatched, without the need for the door to be wide open, thus conserving energy in climate controlled homes and buildings. The versatile Door Stopper could be used with any knob-equipped interior or exterior door, and the Stopper would be equally suitable for use at home or at the office or other workplace. Especially ideal for those who reside in older housing where the doors tend to close on their own, the Door Stopper is one of those simple, easily affordable products that would eliminate a widely shared inconvenience.

Clever in conception, thoughtful in design, inexpensive in price and highly effective, the Door Stopper should find a wide and enthusiastic reception in the consumer markets of America and the world.

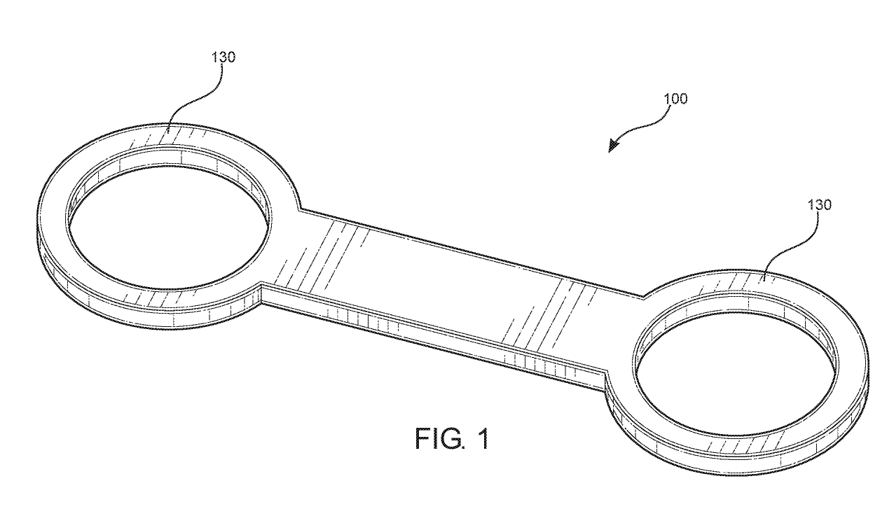

Referring now to FIG. 1, showing perspective views illustrating door knob device 100 according to an embodiment of the present invention of FIG. 1.

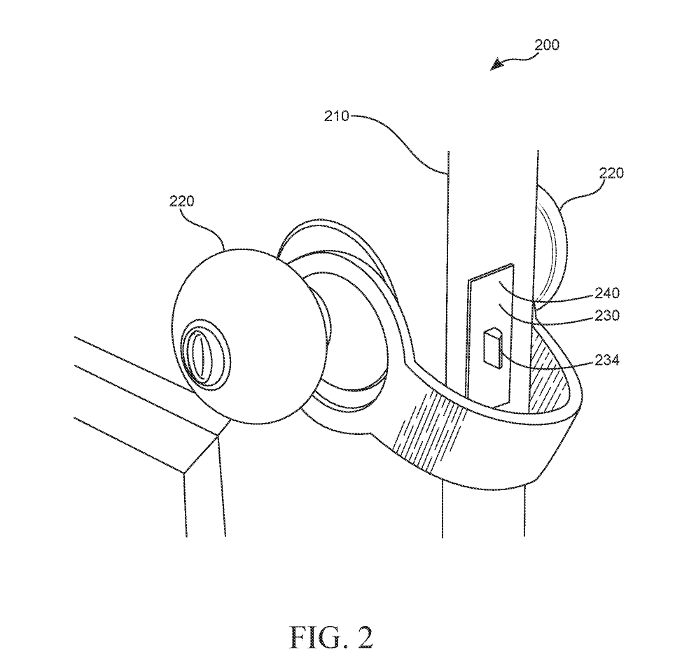

Door knob device 100 for use upon existing door knobs 220 located on door member 210, comprising: two ring members 130; and belt member 160. Two ring members 130 are each adapted to slip over respective opposite door knobs 220 of the door member 210. Two ring members 130 are each formed having an outer diameter of 3½ inches and an inner diameter of 2½ inches, to thereby be adapted to slip over and be retained upon respective door knobs 220 as shown in FIGS. 2 & 3.

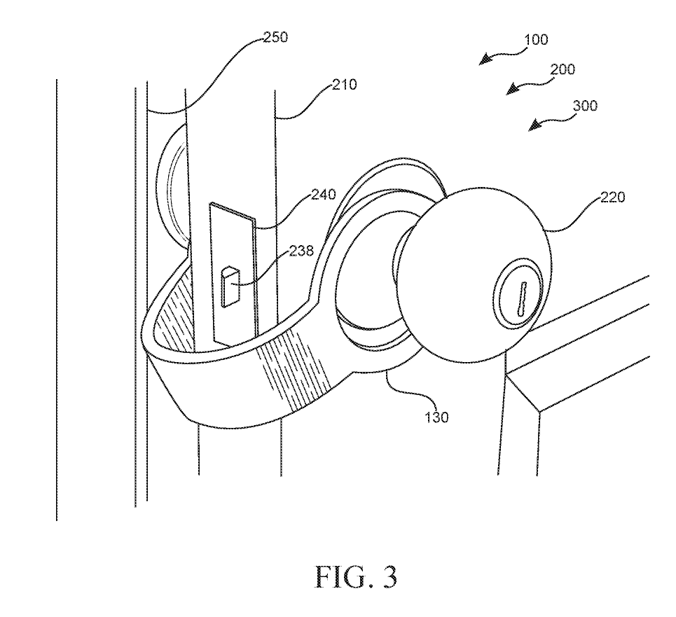

Belt member 160 is connected between two ring members 130 and is adapted to extend around an edge of door member 210 and cover and prevent door latch bolt 234 of door member 210 from extending outwardly therefrom and connecting with strike plate 240 of door frame 250, thereby preventing door member 210 from closing in latched position 300 as shown in FIG. 3. Belt member 160 is formed having an elongated rectangular cross-section. Belt member 160 is formed having a length of 6½ inches.

Door knob device 100 is formed having a length of 14½ inches. Door knob device 100 is formed having a thickness of ¼ inches. Door knob device 100 is formed from rubber or of flexible plastic material. Upon reading this specification, it should be appreciated that, under appropriate circumstances, considering such issues as user preferences, design preference, structural requirements, marketing preferences, cost, available materials, technological advances, etc., other material arrangements such as, for example, other flexible materials with bend and give may be suitably used.

Referring now to FIGS. 2 & 3, showing perspective views illustrating combination of door knob assembly 200 and door knob device 100 for use upon door knob assembly 200 when located on door member 210 according to an embodiment of the present invention of FIG. 1.

A combination of door knob assembly 200 and door knob device 100 for use upon door knob assembly 200 when located on door member 210, the combination comprising: door knob assembly 200 and door knob device 100. Door knob assembly 200 includes two opposing door knobs 220; and latch assembly 230 including latch bolt 234. Latch bolt 234 is adapted to releasably connect with a strike plate member 240 attached to door frame 250 of door member 210. Two opposing door knobs 220 are mechanically and releasably connected to latch assembly 230 when located on door member 210.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A door knob device for use upon existing door knobs located on a door member, comprising:
two ring members;
wherein said two ring members are each adapted to slip over respective opposite door knobs of said door member; and
a belt member;
wherein said belt member is connected between said two ring members and is adapted to extend around an edge of said door member and cover and prevent a door latch bolt of said door member from extending outwardly therefrom and connecting with a strike plate of a door frame, thereby preventing said door member from closing in a latched position.

2. The door knob device of claim 1, wherein said two ring members are each formed having an outer diameter of 3½ inches and an inner diameter of 2½ inches, to thereby be adapted to slip over and be retained upon respective said door knobs.

3. The door knob device of claim 1, wherein said belt member is formed having an elongated rectangular cross-section.

4. The door knob device of claim 2, wherein said belt member is formed having a length of 6½ inches.

5. The door knob device of claim 1, wherein said door knob device is formed having a length of 14½ inches.

6. The door knob device of claim 4, wherein said door knob device is formed having a thickness of ¼ inches.

7. The door knob device of claim 1, wherein said door knob device is formed from rubber.

8. The door knob device of claim 1, wherein said door knob device is formed from a flexible plastic material.

9. A combination of a door knob assembly and a door knob device for use upon said door knob assembly when located on a door member, said combination comprising:
a door knob assembly including:
two opposing door knobs; and
a latch assembly including;
a latch bolt;
wherein said latch bolt is adapted to releasably connect with a strike plate member attached to a frame housing said door member;
wherein said two opposing door knobs are mechanically and releasably connected to said latch assembly when located on said door member; and
a door knob device comprising:
two ring members;
wherein said two ring members are each adapted to slip over respective said two opposing door knobs; and
a belt member;
wherein said belt member is connected between said two ring members and is adapted to extend around an edge of said door member and cover and prevent said door latch bolt of said door knob assembly from extending outwardly therefrom and connecting with a strike plate member of said door frame, thereby preventing said door member from closing in a latched position.

10. The combination of claim 9, wherein said two ring members are each formed having an outer diameter of 3½ inches and an inner diameter of 2½ inches, to thereby be adapted to slip over and be retained upon respective said door knobs.

11. The combination of claim 9, wherein said belt member is formed having an elongated rectangular cross-section.

12. The combination of claim 10, wherein said belt member is formed having a length of 6½ inches.

13. The combination of claim 9, wherein said door knob device is formed having a length of 14½ inches.

14. The combination of claim 12, wherein said door knob device is formed having a thickness of ¼ inches.

15. The combination of claim 9, wherein said door knob device is formed from rubber.

16. The combination of claim 9, wherein said door knob device is formed from a flexible plastic material.
